(19) United States
(12) Patent Application Publication
(10) Pub. No.: US 2007/0232389 A1
(43) Pub. Date: Oct. 4, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/730,578

(22) Filed: Apr. 2, 2007

(30) Foreign Application Priority Data
Apr. 3, 2006 (JP) P2006-102118

(51) Int. Cl. A63F 13/00

(52) U.S. Cl. 463/25

(57) ABSTRACT

The gaming machine includes a display unit that is configured to display a plurality of symbols, an operation unit that allows a player to input commands, and a processor that is operable with the display unit and the operation unit to: perform a base game by using the symbols; determine whether or not a bonus game is won based on a result of the base game; allow the bonus game to be stocked to be performed afterward when determined that the bonus game is won; accept a stock release command input by the player through an operation unit while the bonus game is stocked; and provide the bonus game to the player when the stock release command is accepted.

### CROSS-REFERENCE TO THE RELATED APPLICATION(S)

The present application is based upon and claims priority from prior Japanese Patent Application No. 2006-102118, filed on Apr. 3, 2006, the entire content of which are incorporated herein by reference.

### TECHNICAL FIELD

The present invention relates to a gaming machine, such as a slot machine, which provides a player a game in which symbols aligned in a plurality of arrays are variably displayed.

### BACKGROUND

Conventionally, there is known a gaming machine that provides a player a game by variably displaying a plurality of symbols arranged on a reel. Among variable display devices that are installed in such gaming machine and provide the variable display of the symbols, there is a mechanical-type device that mechanically rotates an actual reel to variably display the symbols and a video-type device that displays an image of a rotating reel on a display device, such as a liquid crystal panel and a CRT.

For example, JP-A-2004-057221 (counterpart U.S. patent application is issued as U.S. Pat. No. 6,893,018 B2) discloses a gaming machine of a video-reel type that variably displays an image of a plurality of reels (a total of nine reels, in three each of vertical and horizontal arrays) on the video-type device. In this gaming machine, an award (for example, a game medium such as a coin or a medal) is paid out to a player in accordance with a symbol combination (a combination of symbols aligned on a BET line) that is displayed stopped on the reels.

Conventional gaming machine, as such described in JP-A-2004-057221, generally provides the player a base game (also called a primary game or a basic game) and a bonus game (also called a secondary game, a second game, or a special game). The base game and the bonus game are selectively provided in accordance with the internal lottery process performed when starting each games. When the bonus game is determined to be performed, the player obtains a chance to obtain a larger amount of the payout (a larger amount of the game medium) than an amount of the payout obtainable in the base game. Therefore, a chance (probability) to start the bonus game is set to be low in the internal lottery process in order to let the player feel excitement in playing the game and prevent the player from getting bored.

The conventional gaming machine is generally configured to stop performing the base game and to perform the bonus game promptly when determined to perform the bonus game by a predetermined condition being established, and when the bonus game is finished, a large amount of award is paid out to the player.

However, there is proposed an alternative configuration, as such disclosed in JP-A-2005-021257, in which even in an event that the bonus game is won in the internal lottery process during the game, the display is controlled not to display a symbol combination for winning the bonus game, and to “stock” the bonus game. Thus configured gaming machine is called a “stock machine”. In this kind of gaming machine, when a predetermined condition is satisfied, the stocked winning condition (stocked bonus game) is discharged, and a large amount of award is paid out to the player.

In conventional the gaming machine that provides the bonus game in addition to the base game, the player gradually feels monotonous while continuing to play the bonus game for a several times, and eventually loses interest in the bonus game itself. Also, as in the stock machine, although the bonus game is stocked, the stocked bonus game is discharged by the predetermined condition being satisfied, the player is by force placed in a passive position, and the player seeking the excitement cannot be satisfied with the conventional gaming machine, and seeks for a proposal of a more novel gaming machine.

### SUMMARY

One of objects of the present invention is to provide a gaming machine that enables a player to positively participate in a game and provide a game with increased strategic characteristics while preventing the player from feeling bored.

According to a first aspect of the invention, there is provided a gaming machine including: a display unit that is configured to display a plurality of symbols; an operation unit that allows a player to input commands; and a processor. The processor is operable with the display unit and the operation unit to: perform a base game by using the symbols; determine whether or not a bonus game is won based on a result of the base game; allow the bonus game to be stocked to be performed afterward when determined that the bonus game is won; accept a stock release command input by the player through the operation unit while the bonus game is stocked; and provide the bonus game to the player when the stock release command is accepted.

According to a second aspect of the invention, there is provided a gaming machine including: a display unit that is configured to display a plurality of symbols; an operation unit that allows a player to input commands; and a processor. The processor is operable with the display unit and the operation unit to: perform a base game by using the symbols; determine whether or not a bonus game is won based on a result of the base game; allow the bonus game to be stocked to be performed afterward when determined that the bonus game is won; accept a stock release command input by the player through the operation unit while the bonus game is stocked; provide the bonus game to the player when the stock release command is accepted; and provide a high-award bonus game that provides the player a larger benefit than a benefit obtainable by playing the bonus game for a number of times being stocked, when the stock release command is accepted while the base game is stocked for a predetermined number or more.

### BRIEF DESCRIPTION OF THE DRAWINGS

In the accompanying drawings:

FIG. 1 is a view showing an external perspective view showing a slot machine according to an embodiment of a gaming machine of the present invention;

FIG. 2 is a block diagram schematically showing a control system of the slot machine;

FIG. 3 is a block diagram showing an example of an internal configuration of an video controller of the slot machine;

FIG. 4 is a view showing an example of a display screen of a main display;

FIG. 5 is a diagram showing an arrangement table of each display area of the slot machine;

FIG. 6 is a flowchart showing a game implementation of the slot machine;

FIG. 7 is another flowchart showing the game implementation of the slot machine;

FIG. 8 is still another flowchart showing the game implementation of the slot machine;

FIG. 9 is still another flowchart showing the game implementation of the slot machine; and

FIG. 10 is still another flowchart showing the game implementation of the slot machine.

### DETAILED DESCRIPTION

Hereafter, a description will be made of a slot machine according to an embodiment of a gaming machine of the present invention, with reference to the accompanying drawings.

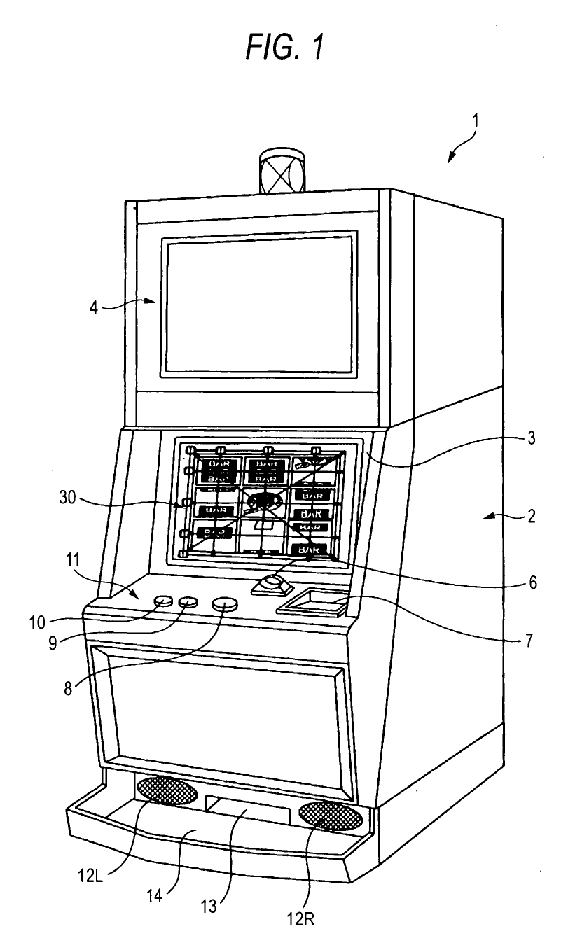

FIG. 1 is a perspective view showing an overall configuration of a slot machine according to the embodiment. A slot machine 1 is provided with a cabinet 2, and a main display 3, which is equipped with a liquid crystal display device, disposed on a front face of the cabinet. The slot machine 1 is further provided with a subsidiary display 4, which is also equipped with a liquid crystal display device, in a portion above the main display 3.

The main display 3 serves as a variable display unit that displays an image of rotating reels on a screen. The screen of the main display 3 is configured to have a symbol display portion 30 that displays a group of symbol display areas. The symbol display portion 30 is configured by a plurality of symbol display areas (in the embodiment, a total of nine symbol display areas 3A, 3B, 3C, 3D, 3E, 3F, 3G, 3H and 31, disposed in three each of vertical and horizontal arrays), in such a way that the plurality of symbol display areas 3A-3I is perceived by a player as one block.

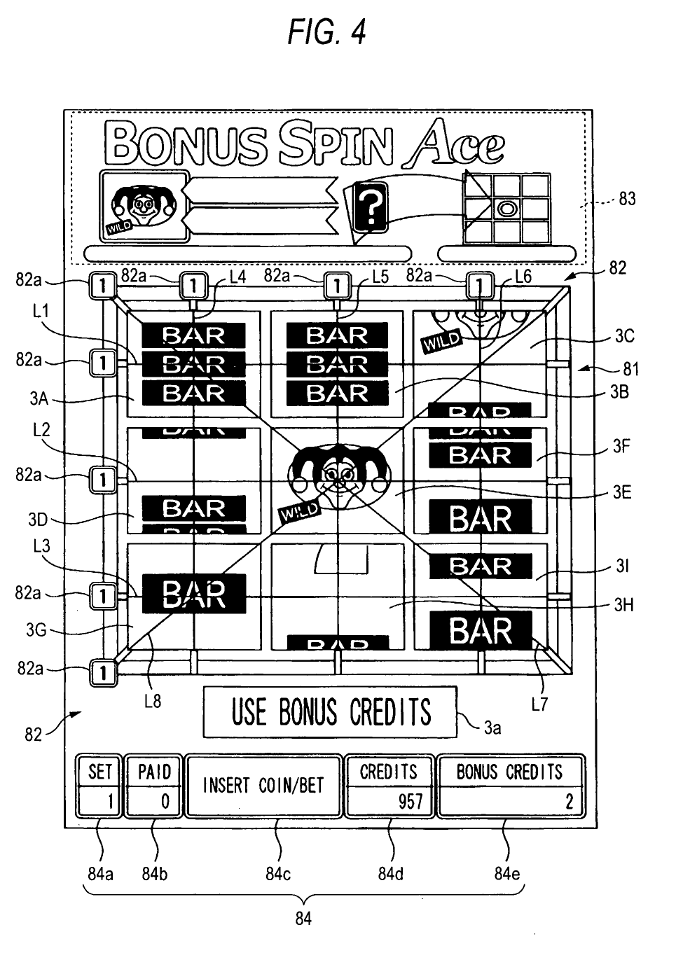

It is preferable to configure the main display 3, as a display device having a transparent touch panel to receive various kinds of commands input by the player touching the touch panel. In the embodiment, the slot machine 1 is provided with a touch panel having a touch sensitive button 3a below the nine symbol display areas 3A-3I (see FIG. 4). As will be described hereafter, when executing a stocked bonus game, the player touches the touch sensitive button 3a to input a command (a stock release command) to execute the stocked bonus game.

A base game, and a bonus game for providing a larger award (game value) to the player than the base game, are provided to the player on the main display 3 by means of a game state control unit (microcomputer 31), which will be described later. In both of the base game and the bonus game, scroll display images (reel images displayed as though mechanical reels is rotating), in which a plurality of symbols moving from a top to a bottom, are displayed in each of the symbol display areas 3A-3I.

In the embodiment, the nine symbol display areas 3A-3I are arranged in the symbol display portion 30. Accordingly, a total of eight pay lines (L1-L8) are set for each of the three vertical arrays, for each of the three horizontal arrays, for arrangements on two diagonal lines. The pay lines are used for determining a symbol combination (see FIG. 4).

The “symbol combination” is a combination of symbols displayed stopped on the symbol display areas arranged under each of the pay lines L1-L8.

On the subsidiary display 4 provided above the main display 3, a payout table and images related to the games such as an explanation of the games (for example, an explanation of game details) are displayed. However, it is also acceptable to replace the subsidiary display 4 with a single panel on which the game details are depicted.

An approximately horizontal pedestal portion 11 is provided below the main display 3. The pedestal portion 11 is provided with a coin insertion slot 6, a bill insertion slot 7, a spin switch 8, a 1-BET switch 9 and a MAX-BET switch 10.

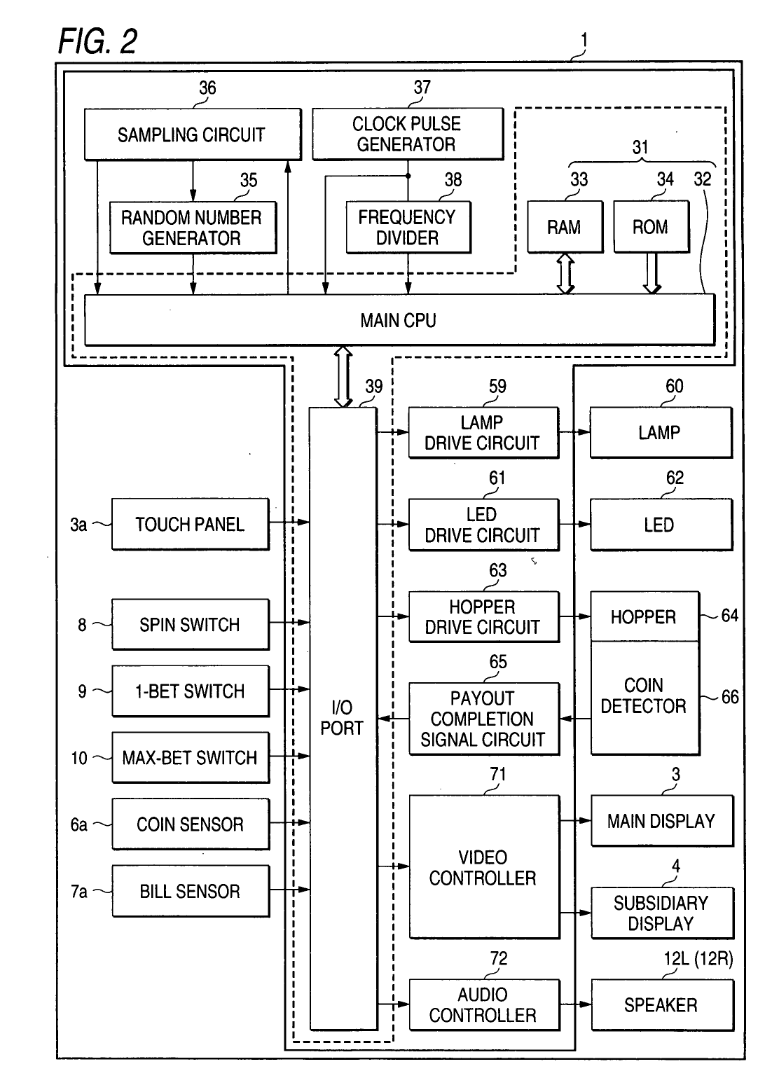

In the embodiment, the coin insertion slot 6 is provided for the player to insert a game medium, such as a coin or a medal (hereafter called a coin), for betting on a game, and has a coin sensor 6a (see FIG. 2) that outputs a signal indicating an insertion of the coin. The bill insertion slot 7 is provided for the player to insert a bill, and has a bill sensor 7a (see FIG. 2) that outputs a signal indicating an insertion of the bill. The spin switch 8 is provided for the player to input an operation for starting a slot game and, by operating the spin switch 8, symbol scroll display images are displayed in the symbol display areas 3A-3I. The 1-BET switch 9 is provided for the player to input an operation for betting one coin with pressing the 1-BET switch 9 once. The MAX-BET switch 10 is provided for the player to perform operation for betting a maximum amount of the coin that is allowed to bet in a single round of the game.

The slot machine 1 is provided with a coin payout opening 13, and a coin receiving tray 14 that receives the paid out coins, at a lower portion of the cabinet 2. The slot machine 1 is further provided with a pair of speakers 12L and 12R, each of which disposed on a left side and a right side of the front face the cabinet 2 to sandwich the coin payout opening 13.

FIG. 2 is a block diagram schematically showing a control system of the slot machine 1. As shown in FIG. 2, the slot machine 1 includes a plurality of components including a microcomputer 31.

The microcomputer 31 has a main CPU (Central Processing Unit) 32, a RAM (Random Access Memory) 33 and a ROM (Read Only Memory) 34. The microcomputer 31 serves as a controller that controls other components to provide a game to the player.

The main CPU 32, operating in accordance with a program stored in the ROM 34, receives signals via an I/O port 39 from the coin insertion slot 6 (the coin sensor 6a), the bill acceptor 7 (the bill sensor 7a), the spin switch 8, the 1-BET switch 9 and the MAX-BET switch 10, which are provided on the touch sensitive button 3a of the main display 3 and the pedestal portion 11. The main CPU 32 performs a control of an operation of a whole of the slot machine 1. Specifically, the program executed by the main CPU 32 and permanent data are stored in the ROM 34, and data and a program used when the main CPU 32 operates in accordance with the operation program of the ROM 34 are stored in the RAM 33. For example, the RAM 33 temporarily stores a random number sampled by a sampling circuit 36, to be described hereafter, after a start of the game, or stocks a number of times the bonus game being won by the player. That is, the main CPU 32, RAM 33 and ROM 34 serves as the game state control unit that controls a game state of the slot machine 1.

The slot machine 1 is provided with a random number generator 35, the sampling circuit 36, a clock pulse generator 37 and a frequency divider 38, which serve as a lottery unit. The random number generator 35 operates in accordance with an instruction from the main CPU 32 to generate random numbers in a certain range. The sampling circuit 36, in accordance with an instruction from the main CPU 32, obtains an optional random number from among the random numbers generated by the random number generator 35, and inputs the obtained random number into the main CPU 32. The clock pulse generator 37 generates a reference clock pulse for operating the main CPU 32, and the frequency divider 38 inputs a signal in which the reference clock pulse is divided by a certain frequency into the main CPU 32.

The slot machine 1 is provided with a lamp drive circuit 59, a lamp 60, an LED driver circuit 61, an LED 62, a hopper drive circuit 63, a hopper 64, a payout completion signal circuit 65 and a coin detector 66. The slot machine 1 is further provided with a video controller 71, which controls the main display 3 and the subsidiary display 4 to display various images thereon, and an audio controller 72, which controls the speakers 12L and 12R to output various sounds such as background music and sound effects.

The lamp drive circuit 59 controls the lamp 60 to perform a visual effect of the game by outputting a signal to the lamp 60 to cause the lamp 60 to flash during the game. The LED drive circuit 61 controls the LED 62 to display a credit amount, a stock count and an acquired coin amount. The hopper drive circuit 63 controls the hopper 64 in accordance with the control by the main CPU 32. The hopper 64, being controlled by the hopper drive circuit 63, performs a payout of the coin, and pays out the coin into the coin payout opening 13.

The coin detector 66 counts an amount of the coin paid out by the hopper 64, and notifies the payout completion signal circuit 65 including data indicating the counted amount of coins. The payout completion signal circuit 65 receives the data from the coin detector 66 and, in the event that the counted amount of coins reaches an amount determined by the result of the game, outputs a signal informing of a coin payout completion to the main CPU 32.

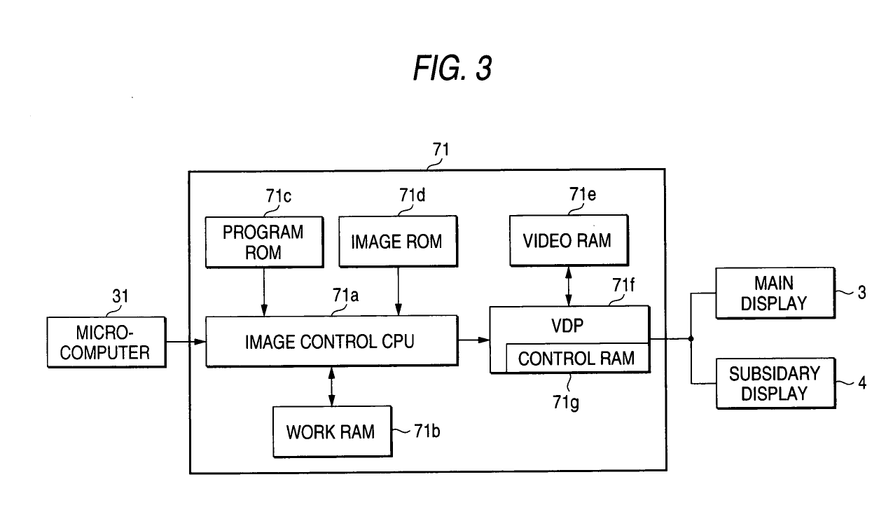

The video controller 71, which serves as a display controller, controls the main display 3 and the subsidiary display 4 to display various images, such as symbol images. As shown in FIG. 3, the video controller 71 is provided with an image control CPU 71a, a work RAM 71b, a program ROM 71c, an image ROM 71d, a video RAM 71e and a VDP (Video Display Processor) 71f.

The image control CPU 71a, based on a parameter set by the microcomputer 31 and in accordance with an image control program stored in advance in the program ROM 71c, determines images (the symbol images or the like) to be displayed on the main display 3 and the subsidiary display 4. The work RAM 71b is configured as temporary storage used by the image control CPU 71a when executing the image control program. The program ROM 71c stores the image control program and various kinds of selection tables. The image ROM 71d stores dot data (bitmap data) for forming the images. In the embodiment, data of various kinds of symbol image are included in the dot data.

Also, the video RAM 71e is configured as temporary storage used by the VDP 71f when forming the images. In the embodiment, the VDP 71f, having a control RAM 71g, forms images corresponding to display details of the main display 3 and the subsidiary display 4 determined by the image control CPU 71a, and outputs the formed images to the main display 3 and the subsidiary display 4.

The audio controller 72 outputs an audio signal for outputting sounds from the speakers 12L and 12R. The sounds are output from the speakers 12L and 12R in order to improve the excitement of the player at an appropriate point in the game, for example, after the start of the game.

FIG. 4 is a view showing an example of a display screen of the main display 3. In the embodiment, a reel display area 81, a pay line display area 82, an upper display area 83 and a lower display area 84 are configured on the main display 3.

In the reel display area 81, symbol display areas 3A-3I in which symbols are to be displayed are provided in a 3×3 matrix. In each of the symbol display areas 3A-3I, a reel image configured by a plurality of symbol images is variably displayed so as that the reel is rotationally displayed, and after being rotationally displayed for a predetermined time, a symbol selected as a stop symbol is displayed to be stopped in an approximate center.

The arrangement of the symbols stopped in the symbol display areas 3A-3I is referred to as a “symbol arrangement” in the description of the embodiment.

The pay line display area 82 including bet amount display portions 82a, each of which displays a number of bets placed on each activated line (pay line) L1-L8 in the game, is provided in an area including a left side and an upper side of the reel display area 81. In the slot machine 1 of the embodiment, eight pay lines are provided: L1, L2 and L3 extending in a horizontal direction, L4, L5 and L6 extending in a vertical direction, and L7 and L8 extending in a diagonal direction, and all of the pay lines L1-L8 are activated by a single bet. When a predetermined symbol combination is arranged on any of the pay lines L1-L8, an award corresponding to details of the symbol combination is paid out to the player.

The upper display area 83, being provided above the reel display area 81 and the pay line display area 82, displays an appellation or a logo of the slot machine 1, a mark designed to explain how to play the game, and the like. The lower display area 84, being provided below the reel display area 81, is configured by a bet amount (BET) display portion 84a, an acquired amount (PAID) display portion 84b, a character information display portion 84c, a credit amount (CREDITS) display portion 84d and a stocked bonus game (stock count) display portion 84e.

An amount of the coins bet on one game is displayed in the bet amount display portion 84a, and an amount of the coins acquired in one game is displayed in the acquired amount display portion 84b. Character information indicating a present status of the game is displayed in the character information display portion 84c and, for example, when the base game transitions into the bonus game, character information informing of the status is displayed. An amount of the coins credited at present is displayed in the stock count display portion 84d. A number of the bonus games being stocked is displayed in the stocked bonus game display portion 84e.

In the example shown in FIG. 4, the stocked bonus game display portion 84e displays the number of the bonus games being stoked under a title “BONUS CREDITS”.

Thirty-two (32) symbols arranged in a predetermined order are circularly displayed to scroll in each of the symbol display areas 3A-3I of the reel display area 81 to let the player feel as if mechanical reels are rotating.

A symbol to be displayed stopped in each of the symbol display areas 3A-3I of the reel display area 81 is determined, for example, in the following way.

When the main CPU 32 detects a start operation (start command) input by the player (for example, by pressing the spin switch 8), in response to the detection (that is, using the start of the game as a trigger), the CPU 32 controls the random number generator 35 to generate random numbers in the certain range. Also, the main CPU 32 controls the sampling circuit 36 to extract the optional random number from among the random numbers generated by the random number generator 35. When the optional random number is extracted, the main CPU 32 sets the optional random number in a search key and, with reference to a symbol determination table (a table correlating and storing symbol code numbers and the random numbers) stored in the ROM 34, obtains a relevant symbol code number.

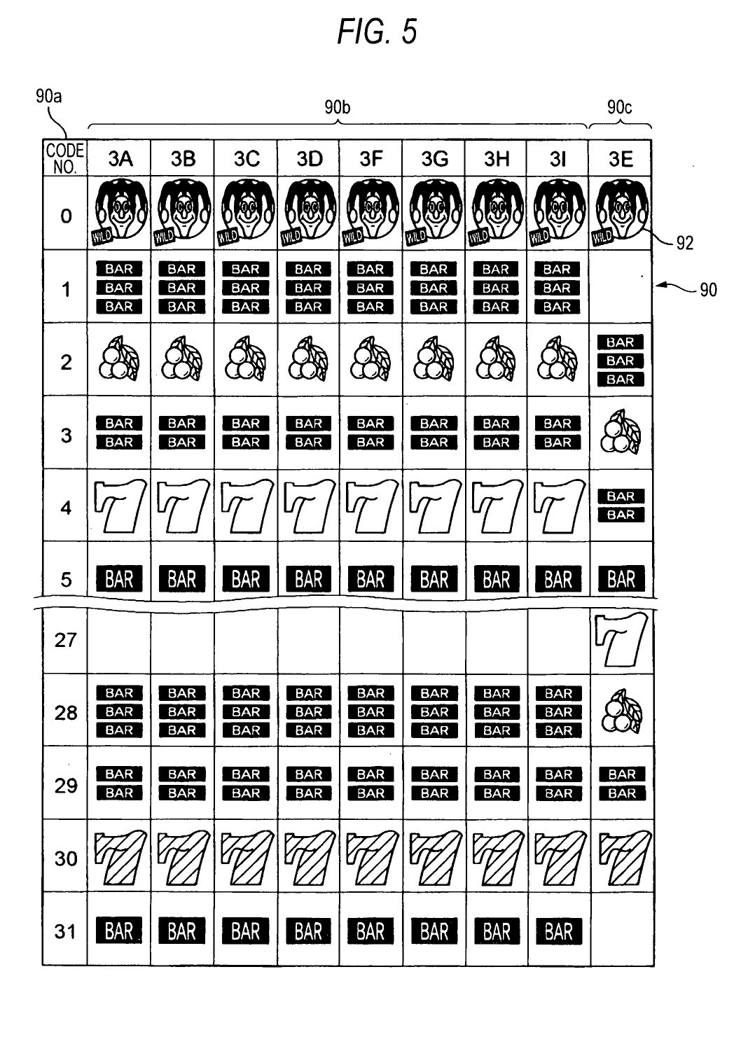

Next, the obtained code number is set in the search key and, with reference to a stop table 90 shown in FIG. 5, a stop symbol to be displayed stopped is searched for each of the symbol display areas 3A-3I.

As shown in FIG. 5, the stop table 90 is a table which has a code number area 90a storing the symbol code numbers, and a first symbol area 90b and a second symbol area 90c storing symbols corresponding to the individual code numbers, and by setting a code number in the search key and searching the code number area 90a, it is possible to search for a relevant symbol with respect to each of the symbol display areas 3A-3I.

The symbols correlated with the code numbers “0” to “31” are registered in the first symbol area 90b and the second symbol area 90c. That is, the stop symbols to be displayed stopped in the symbol display areas 3A-3D and 3F-3I, excluding the central symbol display area 3E, are registered in the first symbol area 90b, and stop symbols to be displayed stopped in the central symbol display area 3E are registered in the second symbol area 90c. In the slot machine 1, the random number extraction and the searching of the symbol determination table is and the stop table 90 are performed for a total of nine times, once for each of the symbol display areas 3A-3I. That is, the table search is performed for a number of times corresponding to a number of the symbol display areas 3A-3I to determine the stop symbols for each of the symbol display areas 3A-3I.

With regard to the stop symbols to be displayed stopped, in accordance with a combination of the stop symbols aligned on each of the pay lines L1 to L8, an award (an amount of the coin to be paid out) is determined in advance based on the payout table.

In the embodiment, a symbol (Wild joker 92) corresponding to the code number “0” in the second symbol area 90c is an advantageous symbol. The Wild joker 92, indicating to the player that it is more advantageous than the other symbols, is configured by combining an image of a face of a joker and a character string “Wild”, as shown in FIG. 5. Specifically, as shown in FIG. 4, when the Wild joker 92 is displayed stopped in the central symbol display area 3E, the player is notified that the bonus game (the bonus game) that pays out the game value relatively advantageous to the player is satisfied. Naturally, it is possible to variously modify how to notify (or the symbol arrangement) that the bonus game is satisfied.

In the arrangement table shown in FIG. 5, the joker symbol positioned in the code number “0”, being a special symbol used as a substitute for any other symbols, is also a so-called wild symbol (almighty symbol). Accordingly, when the joker symbol is stopped in any of the symbol display areas 3A-3I, a symbol combination matching the award combination becomes more likely to be aligned on the pay lines L1-L8. That is, the joker symbol is also a symbol advantageous in winning an award.

In the slot machine 1, either the base game or the bonus game is won in accordance with a result of a lottery process performed when the player inputs the start operation (for example, by pressing the spin switch 8). The slot machine 1 is configured such that, when the bonus game is won in accordance with the result of the lottery process, the bonus game is automatically being “stocked”, and that the stocked bonus game can be played at an arbitrary timing decided by the player.

Although not being limited in particular, the bonus game performed on the slot machine 1 in the embodiment is configured as a right to play a free game for a predetermined number of times (for example, ten times). Specifically, in the free game performed during the bonus game, the player can play the game without inserting the coin (expense of a credit of the coin) or pressing a bet button. That is, when transitioning to (starting) the bonus game, the player can play the game for free for the predetermined number of times (for example, ten times). Accordingly, the player can receive a pay out of the coin without reducing the coin or stock count during the bonus game, and has a great advantage as regards a coin obtainment.

As described above, when the bonus game is won in the lottery process, the bonus game is stocked without being performed promptly, and the stocked bonus game can be started at the arbitrary timing decided by the player (such by the player touching the touch sensitive button 3a).

In the embodiment, the slot machine 1 is configured such that by stocking a predetermined number of times (X times) of the bonus games, the player obtains a chance to receive a special bonus that provides the player a larger benefit (such as a larger amount of coins) than a benefit obtainable by playing X-times of the bonus games being stocked.

The special bonus may be provided to the player by allow playing an additional bonus game when three-times of the bonus game is stocked (allow playing four bonus games in total). The special bonus may be provided to the player by increasing the award to be paid out, or a number of times of free games playable, in each of the bonus games when playing the three-times of the stocked bonus games.

The special bonus may be provided to the player by decreasing a number of times of the playable bonus games (to one-time or to two-times) when playing the three-times of the stocked bonus games, while allowing the player to play the playable bonus games having an extremely larger amount of award to be paid out.

The bonus game provided to the player with this kind of special bonus will be referred to hereafter as a “high-award bonus game”, and the bonus game provided to the player without the special bonus will be referred to as a “normal bonus game”.

The high-award bonus game is configured to be provided to the player when the player touches the touch sensitive button 3a, and is provided to the player at an arbitrary timing decided by the player (at the player's free will). When the player touches the touch sensitive button 3a before the bonus game is stocked for the predetermined number of times (when the stocked bonus game is less than X-times), the high-award bonus game is not provided to the player, but a normal bonus game is provided to the player for a number of times equivalent to the stocked bonus games.

In the slot machine 1 may be configured to notify the player that a condition for obtaining the special bonus is satisfied. In doing so, for example, the slot machine 1 may be configured to notify the player that the condition is satisfied by displaying a message on the character information display portion 84c, by flashing the lamp 60, or by an audial message and sound effects output from the speakers 12L, 12R.

In the embodiment, the main CPU 32 of the microcomputer 31 performs a determination process for determining whether or not a transition condition for transitioning to the bonus game is satisfied in each round of the base game. When the transition condition is satisfied, the main CPU 32 writes stock information into a work area of the RAM 33. The stock information indicates a number of times of the stocked bonus games and indicates that the game is in a state where transitionable to the bonus game. In the embodiment, the transition condition is satisfied when the joker symbol 92 is displayed stopped in the central symbol display area (center reel) 3E.

Next, a game process performed by the slot machine 1 according to the embodiment will be described in detail.

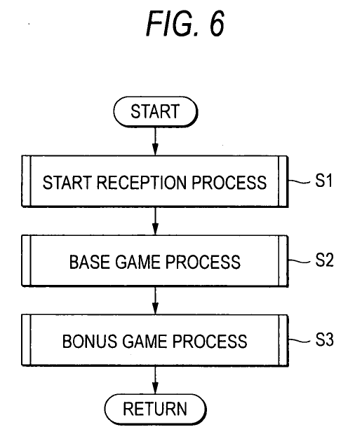

FIGS. 6-10 are flowcharts showing an example of a procedure of the game process performed by the slot machine 1. The following processes are performed by the main CPU 32 executing information related to the slot game of the programs stored in the ROM 34 and the RAM 33.

When a main process is started, the main CPU 32 performs a start reception process (S1). The start reception process is a process for receiving a signal output from a switch, such as the coin sensor 6a, the bill sensor 7a, the touch sensitive button 3a, the spin switch 8, the 1-BET switch 9 or the MAX-BET switch 10, when an operation is input by the player through the switch. The game is started when the signal output from the switch is received.

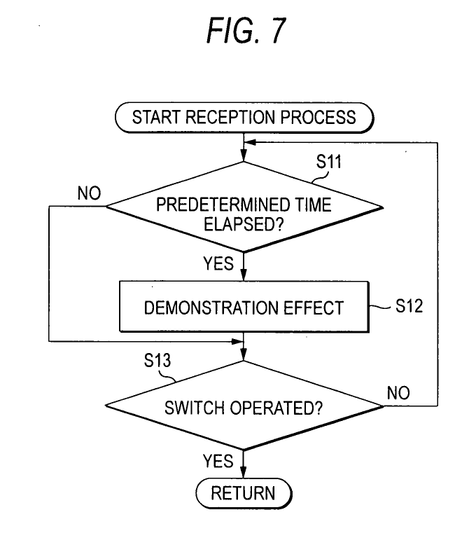

An example of the start reception process will be described with reference to the flowchart shown in FIG. 7.

When the start reception process is started, the main CPU 32 determines whether or not a predetermined time (for example, 15 seconds) is elapsed (S11). When determined that the predetermined time is not elapsed (S11, NO), the process proceeds to S13, and when determined that the predetermined time is elapsed (S11, YES), the process proceeds to S13 after displaying a demonstration image (or demonstration effect) on the main display 3 or the subsidiary display 4 in step S12. In step S13, when the main CPU 32 determines that the switch is not operated (S13, NO), the process returns to S11 to repeat the start reception process. When the CPU 32 determines that the switch is operated (S13, YES), even while displaying the demonstration image, the process returns to the main process shown in FIG. 6 to perform a base game process of step S2.

When the process is returned from the start reception process of step S1 to the main process, the base game process is performed (S2). That is, when coins corresponding to predetermined amount of credits required for starting the game are inserted into the coin insertion slot 6, or while the predetermined amount of the credits is left, the CPU 32 determines whether or not the switches are operated by the player to bet and the spin switch 8 is operated by the player to output a start command for starting the game. When the CPU 32 determines that the game is started, the start reception process S1 is completed, and the process proceeds to the base game process S2.

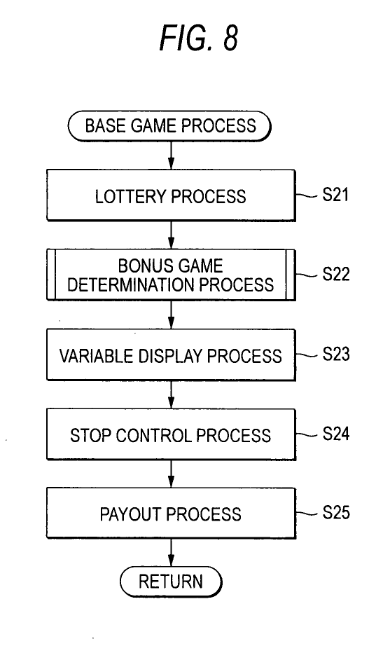

The base game process is performed in accordance with the flowchart shown in FIG. 8. When the base game process is started, the main CPU 32 performs a lottery process (S21). The lottery process S21 is performed by a trigger that the signal is input from the spin switch 8, and the main CPU 32 obtains one random number from the random number sampling circuit 36. Next, by comparing the obtained random number with a random number classification table (not shown) that describes a correlation between random numbers prepared in advance and winning combinations (including a “lose”), the main CPU 32 determines a winning combination corresponding to the obtained random number.

A code number corresponding to a symbol (the stop symbol) to be displayed stopped in each of the symbol display areas 3A-3I being correlated with the determined winning combination, the main CPU 32, with reference to the table shown in FIG. 5, determines the symbol (the stop symbol) to be displayed stopped in each of the symbol display areas 3A-3I of the main display 3. That is, a random number output from the sampling circuit 36 to the main CPU 32 is used to determine the stop symbol. The main CPU 32 serves as a determination unit that, based on the obtained random number, performs a bonus game determination process for determining whether or not the transition condition for transitioning to the bonus game is satisfied (S22).

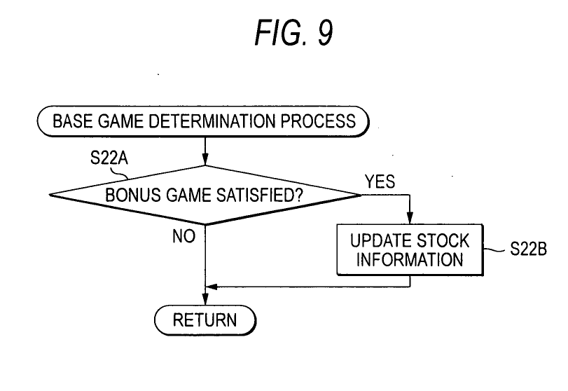

In the bonus game determination process S22, as shown in the flowchart of FIG. 9, the CPU 32 determines whether or not the transition condition for transitioning to the bonus game is satisfied (S22A). When the transition condition is satisfied, the CPU 32 accesses the work area of the RAM 33 and updates stock information that indicates a number of times the transition condition is satisfied (S22B), and terminates the bonus game determination process S22 to proceed the process to step S23. When the transition condition is not satisfied (NO in S22A), the CPU 32 terminates the bonus game determination process S22 and proceeds the process to step S23.

When the bonus game determination process S22 is terminated, the CPU 32 performs a variable display process (S23). The variable display process is a process in which the symbols in each of the symbol display areas 3A-3I of the main display 3 are displayed as an image to be seen as though the mechanical reel having the symbols arranged on an outer peripheral thereof is rotating. Such display of the image is performed by the video controller 71 being controlled by the main CPU 32.

After performing the variable display process S23, in response to a result of the lottery process in S21, the main CPU 32 performs a stop control process for controlling the image displayed on the main display 3 in such a way that a predetermined stop symbol is displayed (S24). The stop control process is performed by the video controller 71 being controlled by the main CPU 32.

When the transition condition is satisfied in the lottery process of S21, the main CPU 32 controls the main display 3 to display the symbols in each of the symbol display areas 3A-3I stopped in the symbol arrangement in order to notify the player that the transition condition is satisfied (S24).

Specifically, when the CPU 32 determines that the transition condition is satisfied based on the random numbers obtained from the sampling circuit 36 and the random number classification table (not shown) stored in the ROM 34, the main CPU 32, with respect to the arrangement (symbol arrangement) of the symbols displayed stopped in each of the symbol display areas 3A-3I, performs a stop control in such a way that the joker symbol 92 is displayed in the central symbol display area (center reel) 3E. That is, when the transition condition is satisfied, the code number for the second symbol area 90c is determined to be “0”). In the embodiment, the player is notified that the transition condition is satisfied by the joker symbol 92 being displayed in the central symbol display area 3E.

In the embodiment, the CPU 32 determines whether or not the bonus game is won (i.e. by determining whether or not the transition condition is satisfied) based on the symbol arrangement that is determined by the random numbers obtained in the lottery process S21.

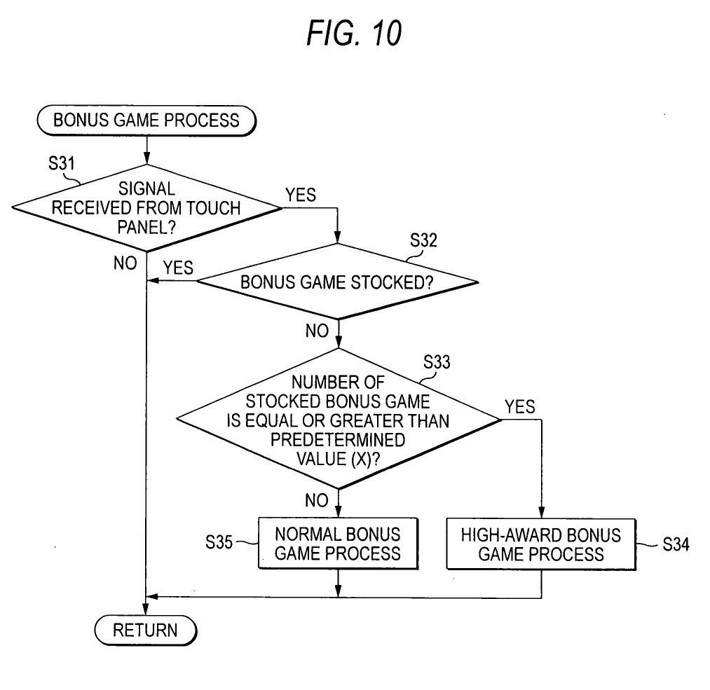

After the stop control process of S24, the CPU 32 performs a payout process S25 in which the coin obtained in the game is paid out, and the CPU 32 terminates the base game process. After the base game process, the CPU 32 performs a bonus game process S3 shown in the flowchart of FIG. 6. The bonus game process S3 is a process started when the player touches the touch sensitive button 3a. When the player decides not to play the bonus game and not touches the touch sensitive button 3a, the CPU 32 returns the process immediately to the start reception process S1 (NO in S31 shown in FIG. 10).

When the player decides to play the bonus game and touches the touch sensitive button 3a (YES in S31), the CPU 32 starts to provide the bonus game to the player. In a case where the touch sensitive button 3a is touched by the player and the bonus game is not stocked, the CPU 32 terminates the bonus game process and returns the process to the start reception process S1 shown in FIG. 6 (S32, YES).

In the bonus game process, the CPU 32 determines whether or not the number of the stocked bonus games (stock count (X)) stored in the RAM 33 is a predetermined value or larger (S33, YES), the CPU 32 performs the high-award bonus game process to provide the high-award bonus game to the player (S34). When the stock count (X) is less than the predetermined value (S33, NO), the CPU 32 provides the normal bonus game to the player for a number of times equivalent to the stock count (X) (S35).

During the bonus games, which include the high-award bonus game and the normal bonus game, an award is paid out to the player as such described for the payout process S25.

In the slot machine 1 according to the embodiment, as described above, when the transition condition is satisfied (when the player wins the bonus game), the winning state of the bonus game is placed under stocked state. The stocked bonus game is performed by the CPU 32 to provide the bonus game to the player when the player touches the touch sensitive button 3a and inputs a stock release command while the bonus game is being stocked. That is, in the slot machine 1, the bonus game is not automatically started in accordance with the game process, but is started at an arbitrary timing decided by the player by inputting the stock release command through the touch sensitive button 3a. Accordingly, the slot machine 1 can provide the game in which the player feels more participated, and provide a game in which strategic characteristics and excitement are improved.

According to the slot machine 1, the player can decide to enjoy the special bonus provided by the bonus game afterward by accumulating (stocking) the chances to play the bonus games as much as possible. The player can also enjoy superior feeling by showing surrounding audience and other players a large amount of payout of coins awarded as a result of the bonus game or the high-award bonus game.

In the embodiment, when the predetermined number of times or more of the bonus games are stocked, the high-award bonus game is provided to the player to pay out a larger amount of the coins than an amount paid out when the bonus games (normal bonus games) are played for a number of times equivalent to the stocked bonus games. Accordingly, the slot machine 1 provides the player an advantage (the special bonus) in stocking the bonus games. Therefore, the player can play the game by aiming to obtain a chance to play such high-award bonus game, whereby a range of interest and strategic characteristic in playing the game can be greatly widened.

Although the description is heretofore made for the slot machine 1 according to the embodiment, the present invention is not limited to the embodiment described in the above, but can be variously modified in the following ways.

The slot machine 1 according to the embodiment is configured such that the main CPU 32 automatically stocks the bonus game when the bonus game is obtained, and that the stocked bonus game can be started at an arbitrary timing decided by the player.

However, the slot machine 1 may be configured to allow the player to select whether to stock the bonus game or to play the bonus game promptly, when the bonus game is won.

The slot machine 1 may be configured to allow the player whether to stock the bonus game. In implementing such configuration, the slot machine 1 is configured such to allow the player to select one mode from a stock mode for stocking the bonus game and a non-stock mode for playing the bonus game promptly when the bonus game is awarded to the player (when the transitional condition is satisfied), by means of a button operation or the like. In the non-stock mode, the bonus game is promptly performed when the bonus game is won, as such as in a conventional slot machine.

A game aspect and a game procedure of the base game, the bonus game (normal bonus game) and the high-award bonus game can be variously modified, apart from the heretofore described embodiment.

The base game may be modified as such that an odds for the award to be paid out may be randomly set when performing the lottery process. The bonus game may be provided to the in various game aspect as such that a hit rate during the free game (provided in the bonus game) is increased while displaying so-called multi-reel groups configured by a plurality of groups of reels arranged in 3×3 arrangement.

As described above, by variously modifying the details of the base game and the gaming aspect of the bonus game and the high-award bonus game, it is possible to provide a gaming machine that attracts more interest of the player.

Also, when performing the stocked bonus game, or when performing the high-award bonus game, it is preferable to provide an audial effect or a visual effect that differs from that output in the base game. By providing such effects, the slot machine 1 can allow the player to feel a superior feeling while attracting the audience and other players.

The slot machine 1 according to the embodiment is described as one example of the gaming machine of the present invention, which has nine symbol display areas 3A-3I. However, the present invention may be implemented to a gaming machine having three sets of reels or to a gaming machine having five sets of reels, of which the reels may either be a mechanical reel or a video reel. Also, the present invention may be implemented to various types of gaming machines that provides a base game and a bonus game, such as, for example, a card game machine that provides a card game or a pachinko machine that provides a pachinko game.

What is claimed is:

1. A gaming machine comprising:
a display unit that is configured to display a plurality of symbols;
an operation unit that allows a player to input commands; and
a processor that is operable with the display unit and the operation unit to:
perform a base game by using the symbols;
determine whether or not a bonus game is won based on a result of the base game;
allow the bonus game to be stocked to be performed afterward when determined that the bonus game is won;
accept a stock release command input by the player through the operation unit while the bonus game is stocked; and
provide the bonus game to the player when the stock release command is accepted.

2. The gaming machine according to claim 1, wherein the display unit is provided with an image display device that displays an image of a plurality of video reels.

3. The gaming machine according to claim 1, wherein the display unit is provided with a plurality of mechanical reels.

4. The gaming machine according to claim 1, wherein the processor is further operable to provide a high-award bonus game that provides the player a larger benefit than a benefit obtainable by playing the bonus game for a number of times being stocked, when the stock release command is accepted while the base game is stocked for a predetermined number or more.

5. The gaming machine according to claim 4, wherein the processor is further operable to notify the player when the number of the stocked bonus game reaches the predetermined number.

6. The gaming machine according to claim 1, wherein the processor is further operable to control the display unit to display a number of the bonus game being stocked.

7. The gaming machine according to claim 1, wherein the processor automatically stocks the bonus game when the bonus game is won.

8. The gaming machine according to claim 1, wherein the processor is further operable to allow the player to select whether to stock the bonus game or to play the bonus game promptly, when the bonus game is won.

9. The gaming machine according to claim 7, wherein the processor is further operable to allow the player to select a mode for playing the game from among a stock mode, in which the bonus game is automatically stocked, and a non-stock mode, in which the bonus game is promptly performed when the bonus game is won.

10. A gaming machine comprising:
a display unit that is configured to display a plurality of symbols;
an operation unit that allows a player to input commands; and
a processor that is operable with the display unit and the operation unit to:
perform a base game by using the symbols;
determine whether or not a bonus game is won based on a result of the base game;
allow the bonus game to be automatically stocked to be performed afterward when determined that the bonus game is won;
accept a stock release command input by the player through the operation unit while the bonus game is stocked; and
provide the bonus game to the player when the stock release command is accepted.

11. The gaming machine according to claim 10, wherein the display unit is provided with an image display device that displays an image of a plurality of video reels.

12. The gaming machine according to claim 10, wherein the display unit is provided with a plurality of mechanical reels.

13. The gaming machine according to claim 10, wherein the processor is further operable to notify the player when the number of the stocked bonus game reaches the predetermined number.

14. The gaming machine according to claim 10, wherein the processor is further operable to control the display unit to display a number of the bonus game being stocked.

15. The gaming machine according to claim 10, wherein the processor is further operable to allow the player to select whether to stock the bonus game or to play the bonus game promptly, when the bonus game is won.

16. The gaming machine according to claim 10, wherein the processor is further operable to allow the player to select a mode for playing the game from among a stock mode, in which the bonus game is automatically stocked, and a non-stock mode, in which the bonus game is promptly performed when the bonus game is won.
